(19) United States
(12) Patent Application Publication
(10) Pub. No.: US 2007/0234032 A1
(43) Pub. Date: Oct. 4, 2007

(54) System and method for chassis management

(75) Inventors: Lien-Hsun Chen, Taipei (TW); Tsung-Pin Wang, Taipei (TW); Hsiao-Fen Lu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,935

(22) Filed: Mar. 30, 2006

(51) Int. Cl. G06F 1/24

(52) U.S. Cl. 713/100

(57) ABSTRACT

A system and method for chassis management is proposed. The chassis management system includes at least one server unit, a first control unit, a second control unit, and a system management bus. The system management bus connects the first control unit and the second control unit to the server unit, so as to enable the first control unit and the second control unit to manage operating conditions of the server unit. One of the first control unit and the second control unit sends a request to search for a master controller. If, within a predetermined period of time the system management bus fails to indicate a master controller address on the system management bus in response to the request, then one of the first control unit and the second control unit is configured to function as the master controller, conversely one of the first control unit and the second control unit is configured to function as the slave controller.

### FIELD OF THE INVENTION

The present invention relates to a system and method for chassis management, and more particularly, to a chassis management system and method for configuring the master controller and the slave controller in a blade server, using a system management bus.

### BACKGROUND OF THE INVENTION

Traditionally, more than twenty blade mainboards may be installed in a blade server chassis when necessary. A blade server has become one of the equipments essential to a highly efficient network system, since it may be intensively provided with a plurality of mainboards to implement higher processing performance.

Normally, one of a plurality of mainboards installed in a blade server may be selected to be a master controller for monitoring the plurality of mainboards. The master controller usually connects to a network system and thereby functions as a channel through which the blade server communicates with the outside. Once the blade server gets trouble, the master controller will send out a message related to the trouble, or a remote monitor will monitor the operating condition of each blade mainboard via the master controller.

In order to avoid the situation that the normal operation of the whole blade server is affected due to the breakdown of the master controller, one of the plurality of blade mainboards is selected to be a slave controller. Once the master controller is found not functioning, the slave controller will take over the work of the master controller and replace the master controller, so as to maintain the normal operation of the blade server.

In the past, in order to effectuate the aforesaid take-over, the work previously executed by the master controller is executed by the slave controller in a hardware manner, that is, by means of a complex programmable logic device (CPLD) selector. It should be noticed that CPLD is well known by those skilled in the art, therefore, the detail description is omitted here. However, the configuration of both the master controller and the slave controller is inflexible, as it is generally achieved by the design method of hardware circuit. Moreover, the master controller and the slave controller are two different structures, thereby relatively increasing the configuration cost of the aforesaid take-over. Also, a complex programmable logic device selector is required to switch to a master controller that can function well, thereby increasing the cost.

### SUMMARY OF THE INVENTION

In light of the above drawbacks in the prior art, an objective of the present invention is to provide a chassis management system and method for conveniently and quickly configuring a master controller and a slave controller in a blade server.

The present invention provides a chassis management system and method for configuring the master controller and the slave controller required by a blade server without increasing the hardware requirements, and switching therebetween in accordance with user's demand, thereby enhancing the flexibility of configuration.

A chassis management system of the present invention comprises at least one server unit, a first control unit and a second control unit, to manage the operating condition of the server unit. The chassis management system of the present invention further comprises a system management bus whereby the server unit is connected to the first control unit and the second control unit. One of the first control unit and the second control unit connects to the system management bus and sends a request to search for the master controller via the system management bus. If within a predetermined period of time the system management bus fails to send the address of the master controller in response to a request, one of the first control unit and the second control unit, which has sent the request to search for the master controller, is configured to function as the master controller, and the address of the master controller on the system management bus is configured; conversely, if within a predetermined period of time the system management bus manages to send the address of the master controller in response to the request, one of the first control unit and the second control unit, which has sent the request to search for the master controller, is configured to function as a slave controller, and the address of the slave controller on the system management bus is configured, so as to enable the system management bus to create a management channel linking the first control unit and the second control unit to the server unit in accordance with the configured addresses of the master controller and the slave controller.

A chassis management method of the present invention, applicable in a chassis management system which comprises at least one server unit, a first control unit, and a second control unit. The first control unit and the second control unit are connected to the server unit via a system management bus, so as to enable the first control unit and the second control unit to manage the operating condition of the server unit. The chassis management method comprises the steps of: first, sending a request to search for a master controller when one of the first control unit and the second control unit is connected to the system management bus; second, configuring one of the first control unit and the second control unit, which has sent the request to search for a master controller, to function as the master controller, and configuring the address of the master controller on the system management bus, when within a predetermined period of time the system management bus fails to send the address of the master controller in response to the request; thirdly, configuring one of the first control unit and the second control unit, which has sent the request to search for a master controller, to function as the slave controller, and configuring the address of the slave controller on the system management bus, when within a predetermined period of time the system management bus manages to send the address of the master controller in response to the request; and fourthly, creating, by the system management bus, a management channel linking the first control unit and the second control unit to the server unit in accordance with the configured addresses of the master controller and the slave controller.

The chassis management system and method of the present invention is proposed to configure the master controller and the slave controller required by the blade server, using the bus characteristic of the system management bus (SM Bus). Therefore, no conventional complex programmable logic device selector is required to configure the master controller and the slave controller, thereby reducing the cost and enhancing the flexibility of configuration.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram of the basic structure of the chassis management system according to the present invention; and

FIG. 2 is a flow chart of the operating process of the chassis management method according to the present invention.

### DETAILED DESCRIPTION OF THE PREFERRED EMBODIMENTS

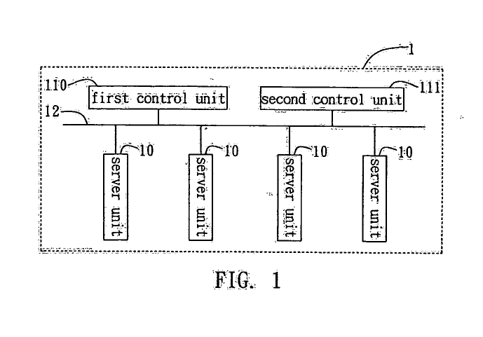

FIG. 1 is a block diagram of the basic structure of the chassis management system according to the present invention. As shown in FIG. 1, the chassis management system 1 of the present invention comprises at least one server unit 10, a first control unit 110, a second control unit 111, and a system management bus 12. The network connection relationships of the server unit 10, the first control unit 110, and the second control unit 111 are created, using the system management bus 12. The chassis management system 1 of the present invention is applied to a blade server, such that the master controller and the slave controller of the blade server are configured, using the bus characteristic of the intelligent platform management bus (IPMB), that is, the system management bus.

The server unit 10 refers to a device which lies in the blade server and needs to be managed, such as a KVM (a keyboard, video, and mouse) module that provides data output/input processing, or multiple blade mainboards, and so on. The first control unit 110 and the second control unit 111 are configured to manage all operating conditions of the server units 10. Each control unit (110, 111), for example, is one selected from the blade mainboards in the blade server, or a circuit board externally connected to the blade server. The structure of each control unit (110, 111) may be adjusted (i.e. be changed or remains unchanged) when necessary. The number of the control units is not necessarily two, that is, one first control unit 110 and one second control unit 111 as specified in this embodiment; instead, a plurality of control units may be used as well. Further, in this embodiment, only one control unit is configured to function as the master controller and the other control units as slave controllers. Specifically, in this embodiment, a control unit which is connected to the system management bus 12 first is regarded as the master controller, whereas any subsequently connected control units are regarded as slave controllers.

It should be noticed that the server unit 10, the first control unit 110, the second control unit 111, and the system management bus 12 are necessary components of a general blade server, and that the involved techniques are well known by those skilled in the art, thus a detailed, related description is omitted here. The following description is focused on how the chassis management system of the present invention configures one of the first control unit 110 and the second control unit 111 to function as the master controller and further creates a management channel linking each control unit (110, 111) to the server unit 10.

One of the first control unit 110 and the second control unit 111 sends a request to search for a master controller via the system management bus, when connected to the system management bus. If, within a predetermined period of time, the system management bus 12 fails to send the address of the master controller on the system management bus 12 in response to the request, the control unit (110 or 111), which has sent the request to search for the master controller, is configured to function as the master controller, and the address of the master controller on the system management bus 12 is configured. Conversely, if within a predetermined period of time the system management bus 12 manages to send the address of the master controller on the system management bus 12 in response to the request, the control unit (110 or 111), which has sent the request to search for the master controller, is configured to function as the slave controller, and the address of the slave controller on the system management bus 12 is configured. Eventually, the system management bus 12 creates a management channel linking the first control unit 110 and the second control unit 111 to the server unit 10 in accordance with the configured addresses of the master controller and the slave controller.

Moreover, forced-switching still may be performed on resultant configuration according to user demand, if a user wants to modify the resultant configuration after the master controller and the slave controller of the first control unit 110 and the second control unit 111 have been configured. One of the implementations, for example, involves providing the control unit (110 or 111) with an input unit (not shown), such as a button, so as to enable the system management bus 12 to perform a switch operation in accordance with the configured addresses of the master controller and the slave controller after a switch signal inputted by the user is received by the input unit. Further, another implementation, for example, involves providing the control unit (110 or 111) with a network transmission interface, such as a network adapter; the network transmission interface connects the control unit (110 or 111) to a network system (for example, an intranet, the Internet, and so on) from which the control unit (110 or 111) may receive a switch signal, such that forced-switching between the master controller and the slave controller occurs to the control units (110 and 111).

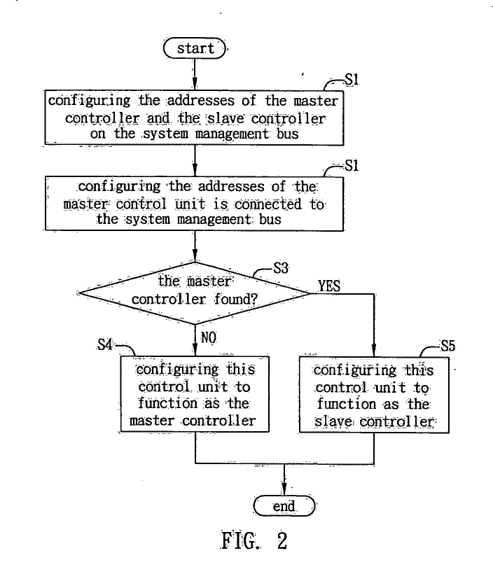

FIG. 2 is a flow chart of the operating process of the chassis management method according to the present invention. In step S1, the addresses of the master controller and the slave controller are respectively defined on the system management bus 12 of the chassis management system 1, wherein the control units (110 and 111) are alternatively connected to the system management bus 12 of the chassis management system 1 and configured to function as the master controller and the slave controller respectively. Then, go to step S2.

In step S2, one of the first control unit 110 and the second control unit 111 gets connected to the system management bus 12, and then performs an initialization operation, or, in other words, sends a request to search for the master controller via the system management bus 12. Then, go to step S3.

Step S3 involves determining if the master controller is found. In other words, in Step 3, one of the first control unit 110 and the second control unit 111 that has sent the request to search for the master controller determines, within a predetermined period of time, whether the system management bus 12 has ever indicated, in response to the request, that a control unit (110 or 111) is provided on the master controller address defined by the system management bus 12. If the system management bus 12 has indicated that a control unit is provided on the defined master controller address (indicating that the master controller is found), then go to step S5; otherwise, go to step S4.

In step S4, one of the first control unit 110 and the second control unit 111 that has sent the request to search for the master controller is configured to function as the master controller, and the address of the master controller on the system management bus 12 is configured. Then, the process for configuring the master controller of the chassis management method of the present invention is finished.

In step S5, one of the first control unit 110 and the second control unit 111 that has sent the request to search for the master controller is configured to function as the slave controller, and the address of the slave controller on the system management bus 12 is configured. Then, the process for configuring the slave controller of the chassis management method of the present invention is finished.

It should be noticed that, in order to prevent two master controllers from simultaneously existing due to the extremely synchronous initializations of the two control units (110 and 111) following their connection with the system management bus 12, the characteristic of IPMB of the system management bus is utilized during the initialization of the control unit (110 or 111), that is, where the bus is occupied by one control unit (110 or 111) and thus another control unit (110 or 111) needs to wait, and after the bus is released, the control unit waits for a short period of time before sending the start bit of the IPMB packet. Therefore, the conflict of two control units being (110 and 111) simultaneously configured to function as the master controller can be avoided.

In conclusion, in the chassis management system 1 of the present invention, upon connection of the control units (110 and 111) with the system management bus 12, it is determined in advance whether the master controller exists or not, so as to conveniently and quickly configure the master controller and the slave controller. Moreover, since the system management bus 12 is a commonly used interface for communication between individual blade mainboards inside a blade server, the master controller and the slave controller can be configured without increasing the hardware requirements. As a result, flexibility of configuration is enhanced, and no complex programmable logic device (CPLD) selector is required to switch between the master controller and the slave controller, thus solving the problem of high costs incurred by conventional CPLD-based configuration of the master controller and the slave controller.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A chassis management system, comprising:
at least one server unit;
a first control unit and a second control unit for managing operating conditions of the server unit; and
a system management bus for connecting the server unit to the first control unit and the second control unit, allowing one of the first control unit and the second control unit, when connected to the system management bus, to send a request to search for a master controller via the system management bus; wherein if within a predetermined period of time the system management bus fails to indicate a master controller address on the system management bus in response to the request, then one of the first control unit and the second control unit, which has sent the request to search for the master controller, is configured to function as the master controller, and the master controller address on the system management bus is configured; or if within the predetermined period of time the system management bus manages to indicate the master controller address on the system management bus in response to the request, then one of the first control unit and the second control unit, which has sent the request to search for the master controller, is configured to function as a slave controller, and a slave controller address on the system management bus is configured; and wherein the system management bus creates a management channel linking the first control unit and the second control unit to the server unit in accordance with the configured addresses of the master controller and the slave controller.

2. The chassis management system of claim 1, further comprising an input unit for inputting a switch signal, such that forced-switching between the master controller and the slave controller occurs to the first control unit and the second control unit.

3. The chassis management system of claim 2, wherein the input unit is installed in the first control unit and the second control unit.

4. The chassis management system of claim 1, wherein the first control unit and the second control unit further comprise a network transmission interface connected to a network system and for receiving a switch signal transmitted from a remote device via the network system, such that forced-switching between the master controller and the slave controller occurs to the first control unit and the second control unit.

5. A chassis management method applicable in a chassis management system which comprises at least one server unit, a first control unit, a second control unit, and a system management bus, wherein the system management bus connects the first control unit and the second control unit to the server unit so as to enable the first control unit and the second control unit to manage operating conditions of the server unit, the method comprising the steps of:
sending a request to search for a master controller when one of the first control unit and the second control unit is connected to the system management bus;
configuring one of the first control unit and the second control unit, which has sent the request to search for the master controller, to function as the master controller and configuring a master controller address on the system management bus when within a predetermined period of time the system management bus fails to indicate the master controller address on the system management bus in response to the request;
configuring one of the first control unit and the second control unit, which has sent the request to search for the master controller, to function as a slave controller and configuring a slave controller address on the system management bus when within the predetermined period of time the system management bus manages to indicate the master controller address on the system management bus in response to the request; and
creating a management channel linking the first control unit and the second control unit to the server unit in accordance with the configured addresses of the master controller and the slave controller.

6. The chassis management method of claim 5, wherein after creating the management channel linking the first control unit and the second control unit to the server unit in accordance with the configured addresses of the master controller and the slave controller, the system management bus further performs forced-switching operation between the master controller and the slave controller on the first control unit and the second control unit in accordance with a received switch signal.

7. The chassis management method of claim 6, wherein the switch signal received by the system management bus is from one of the first control unit and the second control unit.

8. The chassis management method of claim 6, wherein the switch signal is received by an input unit installed in the first control unit and the second control unit.

9. The chassis management method of claim 6, wherein the switch signal is received by a network transmission interface provided in one of the first control unit and the second control unit and connected to a network system, so as to receive the switch signal transmitted from a remote device via the network system.
